(19) United States
(12) Patent Application Publication
(10) Pub. No.: US 2023/0312993 A1
(43) Pub. Date: Oct. 5, 2023

(54) GEOMETRICALLY DEFINED PRESSURE-SENSITIVE ADHESIVE FILM

(71) Applicant: LOHMANN GMBH & CO. KG, Neuwied (DE)

(72) Inventors: Florian DÜMMLER, Neuwied (DE); Ruben FRIEDLAND, Andernach (DE)

(21) Appl. No.: 18/030,560

(22) PCT Filed: Oct. 7, 2020
(86) PCT No.: PCT/EP2020/078187

§ 371 Date: Apr. 6, 2023

(51) Int. Cl. C09J 7/38; C09J 7/10; C08J 5/18

(52) U.S. Cl. CPC C09J 7/385; C09J 7/10; C08J 5/18; C09J 2301/10; C09J 2301/302; C09J 2301/312; C09J 2433/00; C08J 2333/08

(57) ABSTRACT

The present invention relates to a geometrically defined pressure-sensitive adhesive film which is produced in a continuous roll-to-roll process by means of a polyjet modeling method, wherein, due to this printing process, adhesive films no longer have to be subsequently stamped, which contributes to avoiding waste and thus conserving resources.

### TECHNICAL AREA

The present invention relates to a geometrically defined pressure-sensitive adhesive film, which was produced by means of a polyjet modeling method.

### PRIOR ART

Coating facilities, which typically coat the full width of the liner, are used for coating adhesive compounds, to a very limited extent, certain coating geometries (punctiform or strip-shaped) are also possible in such facilities. In any case, however, neither fully free variation of the geometries in a single coating pass is possible, nor is it possible to produce different geometries, as are required, for example, for adhesively bonding emblems consisting of different letters or other characters, in a single coating pass. To generate such geometries, a shaping process is typically used following the coating process, in particular a stamping process. This procedure has the disadvantage of the often low degree of material utilization, since up to 90% waste results upon the creation of the stamped parts, which cannot be used.

In previous conventional coatings, all known coating methods are available such as tape polymerization, hotmelt coating, and drying of water-based or solvent-based systems.

A rapid prototyping method in this context is a method for producing a geometrically defined adhesive layer by means of the polyjet modeling or inkjet method. An adhesive layer produced in this way is preferably used as a carrier-free adhesive tape (transfer tape) but can also form an adhesive layer of an adhesive tape. Adhesive layers which are to be used as a pressure-sensitive tape and are not to be equipped with a stable carrier may only be brought into a geometrically defined shape with difficulty or not at all.

All previous attempts to effectuate this using the typical current production methods have resulted in damage to the tape produced or make it unusable. The novel production method of the polyjet modeling method according to the invention falls in the category of the methods designated as “rapid prototyping” or “additive manufacturing” and is thus a “3D-printing” application in the broadest sense.

Methods for producing adhesive surfaces by means of a 3D-printing method are already known from the literature. Thus, WO 2019/120818 A1 describes in very general form the production of an adhesive surface by applying an adhesive to at least one surface of a component or a transfer adhesive carrier by means of a 3D-printing device. The corresponding 3D-printing device is also claimed herein, which operates according to the inkjet principle or is fed by an endless strand, as well as the method for adhesively bonding two components. This method is furthermore claimed for a broad selection of greatly differing types of adhesive, which can be used here for both homogeneous and different layer thicknesses.

Especially photo-curable resin compositions for 3D-printing are the theme of EP 3597668 A1 and EP 3597669 A1, the printing method used here can be a so-called “material jetting” method or a stereolithographic method.

EP 3196000 B1 describes a method for producing a composite material component by printing a component skeleton and introducing a resin into this skeleton. The skeleton can be printed by means of a polyjet printing process. WO 2019/1215170 A1 describes an aqueous acrylate adhesive dispersion for 3D-printing, WO 2020/146452 A1 describes an additive production process using an amine-containing adhesive polymer, and finally WO 2020/165193 A1 claims a 3D-printing method using a film containing metal powder. The production of adhesives and adhesive products by means of additive production methods is finally the theme of WO 2017/117035 A1; an adhesive precursor composition is applied to a radiation-transmissive surface here, subsequently various sections are irradiated using different radiation doses and in different radiation duration in each case, so that finally an adhesive surface having different properties results.

In the project “Resource-efficient creation of pressure-sensitive molded parts by generative printing methods”, which was promoted by the Deutsche Bundesstiftung Umwelt [German Federal Foundation for the Environment] under the file number DBU-AZ 32912/01, a method based on a rotation gravure printing is described. UV-cross-linking pressure-sensitive adhesives are applied here in the form of the gravure printing method to liners and geometrically defined printed products are thus produced.

None of the mentioned intellectual property or literature citations describes the production of a geometrically defined, preferably also solvent-free adhesive layer using a rapid prototyping method, however, especially a polyjet modeling method, which saves both starting material and also waste, as described in more detail hereinafter.

The terms used in the following statements are to be understood as follows here:

“Adhesive film” means hereinafter any form of planar adhesive system, thus not only adhesive films, but also adhesive tapes, adhesive foils, adhesive strips, adhesive plates, or adhesive stamped parts. Furthermore, the expression “adhesive tape” or “adhesive film” also comprises so-called “transfer films”, i.e., carrier-free adhesive tapes.

“Pressure-sensitive”, “adhesive,” or “contact” adhesive compounds designates adhesive compounds or adhesive films which are capable of connecting two joining partners to one another by only applying pressure. In particular, a permanent connection between the joining partners can be implemented under relatively weak contact pressure. The connection is reversible, i.e., it can be released again without destroying the components.

“3D-printing” means hereinafter the application of adhesive compounds in the inkjet method or polyjet modeling method to a liner. The terms are used anonymously.

“Room temperature” is understood as a temperature of 23±2° C.

### DESCRIPTION OF THE INVENTION

Proceeding from the known prior art, it is an object of the present invention to provide a geometrically defined pressure-sensitive adhesive film, which was produced by means of a rapid prototyping method, especially a waste-saving polyjet modeling method in a continuous roll-to-roll process.

The objects are achieved by a geometrically defined pressure-sensitive adhesive film having the features of claim 1. Advantageous refinements result from the dependent claims, the description, and the figures.

Accordingly, a geometrically defined pressure-sensitive adhesive film based on a generative printing method is specified, wherein the pressure-sensitive adhesive composition particularly comprises acrylates and rubbers.

According to the invention, hotmelts, UV acrylates, and solvent-based and water-based acrylates are therefore processed and printed in geometrically defined forms using the polyjet modeling method.

Furthermore, it is possible in one embodiment to produce the geometrical form in all spatial directions, so that not only two-dimensional adhesive tapes having geometric definition, but also three-dimensional adhesive tapes having geometrical definition can be produced.

In one preferred embodiment, a pressure-sensitive adhesive film produced in this way has an adhesion of at least 0.2 N/mm. The adhesion is determined in this case on steel based on DIN EN 1939:1996 at 23° C.±2° C. and 50%±5% relative ambient humidity at a pull-off speed of 300 mm/minute and a pull-off angle of 180°. An etched PET film having a thickness of 50 μm is used as a reinforcing film in the course of the test. The adhesive bonding of a 25 mm wide measurement strip on the steel substrate is performed here by means of a contact roller of 5 kg at a temperature of 23° C.±2° C. The adhesive film is pulled off 10 minutes after the application at 300 mm/minute. The measured value (in N/mm) results as the mean value from five individual measurements.

Contact adhesive compounds are permanently pressure-sensitive at room temperature, thus have a sufficiently low viscosity and a sufficiently high initial stickiness so that they wet the surface of the respective adhesion base already with low contact pressure. The ability to adhesively bond adhesive compounds is based on their adhesive properties and the ability to release again is based on their cohesive properties.

In one preferred embodiment, the geometrically defined pressure-sensitive adhesive film is carrier-free and thus suitable for forming a transfer film.

In a transfer film or transfer adhesive tape, the adhesive compound, which corresponds in the final state to the finished adhesive film, is applied before the application to a flexible material, such as a film, or between two flexible materials. These materials are designated as release liners, they are provided with a release layer toward the adhesive surface and/or have anti-adhesive properties.

If two liners are used, for example, to apply the adhesive film, first one liner is removed and the adhesive film is applied with the now exposed adhesive surface on a first component. The second liner is then subsequently removed and the adhesive surface now exposed is connected to the second component. The adhesive compound can thus be used directly for connecting two surfaces.

Very accurate adhesive bonding with respect to positioning and metering is enabled by such a pressure-sensitive, carrier-free transfer adhesive film.

There is also the possibility of producing adhesive films or adhesive tapes using a combination of various adhesives or adhesive systems. Thus, for example, the first layer can be a UV acrylate layer and the second layer can be a rubber-based hotmelt. It is thus possible to implement an asymmetrical adhesive tape structure having all adhesive compounds mentioned hereinafter by way of different printheads connected in succession. One of these printed-on adhesive compounds can also function as a carrier system, so that all conceivable layer structures are technically possible.

Adhesive films or adhesive tapes are also possible in which two liners are not used, rather only a single double-sided repellent liner. A first side of the adhesive film is covered in this case with one side of the double-sided liner equipped to be repellent and a second side of the adhesive film is subsequently covered with the rear side of the double-sided liner equipped to be repellent as it is rolled onto a roll or a coil.

In a further embodiment, the geometrically defined pressure-sensitive adhesive film includes at least one carrier. If a carrier material is provided, it can be provided on one or preferably both sides with a geometrically defined (contact) adhesive compound.

The carrier material comprises all planar formations, such as films, foams, woven materials, laid webs, nonwoven materials, and papers or also combinations thereof. Different carriers are combinable with the adhesive compounds for various applications. In this embodiment, only the carrier material is to be finished if needed, due to which the total waste is significantly reduced in comparison to the standard coating and stamping process.

In one preferred refinement, the thickness of the geometrically defined contact adhesive compound, both in the form of a transfer adhesive film and also coated on a planar formation, is between 1 μm and 3000 μm, more preferably between 10 μm and 2000 μm, and particularly preferably between 50 μm and 1000 μm.

Layer thickness is between 100 μm and 1000 μm are best suitable for bridging tolerances in the components to be adhesively bonded. Layer thicknesses between 1 μm and 50 μm result in decreased adhesion on the components, but reduce the material used at the same time.

All adhesive compounds based on UV acrylates which are known to a person skilled in the art are used as adhesive compounds, which can be polymerized by means of UVA, UVB, or UVC, as well as all adhesive compounds based on hotmelt known to a person skilled in the art.

Furthermore, all adhesive compounds known to a person skilled in the art based on solvent-based and water-based acrylates are used, which are dried in a following step directly after the nozzle.

Examples of such adhesive compounds are sufficiently known and described in adhesive practice and in the literature.

In one preferred refinement, the adhesive compounds are partially functionalized, so that a functional adhesive film results. Introductions of functionalities can be by means of fillers to create electrically or thermally conductive adhesive films or adhesive tapes, and by the introduction of drugs or medical active ingredients to create active ingredient patches. The functionalities can be applied in a defined geometric manner by the polyjet modeling method, which contributes to material efficiency and at the same time to improving the required functionality.

In a further preferred embodiment, the functionalization is for (partial) coloration of the adhesive films, and for functionalization by means of biocides and herbicides.

### BRIEF DESCRIPTION OF THE FIGURES

Preferred further embodiments of the invention are explained in more detail by the following description of the figures. In the figures:

FIG. 1 shows a complex geometrically defined pressure-sensitive adhesive film according to one embodiment; and

FIG. 2 shows a schematic illustration of a roll-to-roll method.

### DETAILED DESCRIPTION OF PREFERRED EXEMPLARY EMBODIMENTS

Preferred exemplary embodiments are described hereinafter on the basis of the figures. Identical, similar, or identically-acting elements are provided in the different figures with identical reference signs, and a repeated description of these elements is partially omitted to avoid redundancies.

Production of the Geometrically Defined Pressure-Sensitive Adhesive Layers

To produce the respective geometrically defined pressure-sensitive adhesive layers, the respective contact adhesive compounds are provided in storage containers. The printing viscosity is between 2 mPas and 100 mPas, preferably between 5 mPas and 20 mPas.

Subsequently, the adhesive is applied by means of piezoactuators in the nozzles at frequencies between 10 kHz and 100 kHz, preferably between 12 kHz and 60 kHz, to the liner. The applied drop volume can vary between 2 and 200 pl (picoliters), typically between 10 and 100 pl.

To produce the adhesive compound layers, that is to say the carrier-free contact adhesive tapes, the various adhesive compounds (UV acrylate, solvent-based or water-based system) are applied to a conventional liner (siliconized polyester film) by means of a printhead in the inkjet method (layer by layer) and irradiated or dried immediately thereafter either using a UV lamp having UVA, UVB, or UVC. The thickness of the transfer film is 300±20 μm thereafter. The adhesive films thus produced are each laminated immediately after the polymerization or drying using a second liner (siliconized polyester film having lower release force than the first liner) on the still open adhesive side.

Exemplary Production of the Geometrically Defined Pressure-Sensitive Adhesive Film.

In the present example, a standard UV acrylate from Lohmann was used, which consists of 2-ethylhexylacrylate, acrylic acid, and a radical photo initiator.

This was printed using a Fujifilm Dimatix Q-class printhead in a width of 64 mm at a drop volume of 80 pl. The shaping was selected similarly to the test guidelines described hereinafter and thus in the form of test strips having a thickness of approximately 300 μm (example K1).

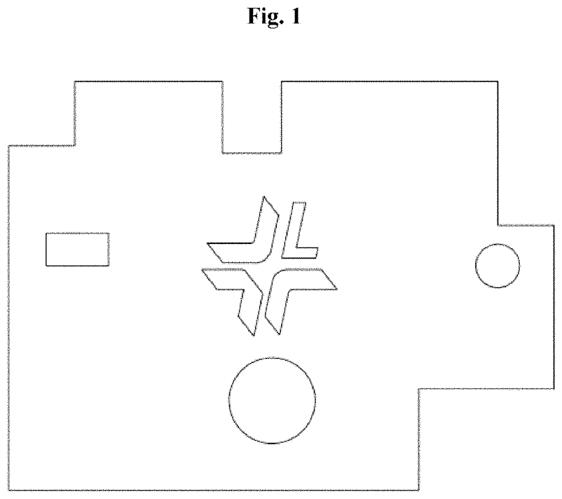

At the same time, a more complex geometry similar to FIG. 1 was printed in order to study the limits of the method.

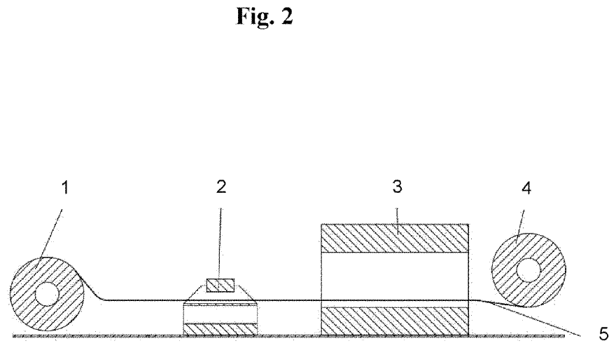

The geometrically defined pressure-sensitive adhesive film was produced in a continuous roll-to-roll process (FIG. 2). The reference signs have the following meaning:

In parallel thereto, an adhesive film having the identical formula was coated on the identical liner in a thickness of 500 μm (R1) by means of a coating facility, in order to be able to judge the mechanical performance of the adhesive film produced in the polyjet modeling method by comparison.

Results of the Contact Adhesive Compounds with Respect to Thickness, Adhesion, and Tensile Shear Strength

Adhesion:

The adhesion is determined on steel based on DIN EN 1464:2010 at 23° C.±2° C. and 50%±5% relative ambient humidity at a pull-off speed of 300 mm/minute and a pull-off angle of 110° in the roll peeling test. An etched film made of PET having a thickness of 50 μm is used as the reinforcing film. The adhesive bonding of a 25 mm wide measurement strip on the steel substrate is performed here by means of a contact roller of 5 kg at a temperature of 23° C.±2° C. The adhesive film is pulled off 10 minutes (initial) or 24 h (24 h) after the application at 300 mm/minute. The measured value (in N/mm) results as the mean value from five individual measurements including standard deviation.

Thickness:

As the characteristic variable for the thickness of the adhesive film, thickness measurements are performed based on DIN EN 1942:2008 at 23° C.±2° C. and 50%±5% relative ambient humidity. The results are specified in mm. The mean value from five measurements is specified in each case.

Tensile Shear Strength:

As the characteristic variable for the strength of the adhesive bonds on steel, tensile shear tests are carried out according to DIN EN 1465 at 23° C.±2° C. and 50%±5% relative ambient humidity and a test speed of 10 mm/minute. Steels made of alloy 1.4301 are used as the test substrates, which are cleaned using acetone, on the one hand, and are subjected to a mechanical surface treatment by means of cross grinding, on the other hand. The samples are produced by means of a contact roller of 5 kg at a temperature of 23° C.±2° C. and tested 24 h after the application. The results are specified in MPa (N/mm²). The mean value from five measurements including standard deviation and fracture pattern assessment is specified in each case.

| Example: | K1 | R1 |
|---|---|---|
| Thickness [mm] | 0.30 ± 0.02 | 0.50 ± 0.05 |
| Adhesion (initial) [N/mm] | 1.40 ± 0.10 (AF/CF) | 1.32 ± 0.10 (AF/CF) |
| Adhesion (24 h) [N/mm] | 1.69 ± 0.05 (AF/CF) | 1.65 ± 0.04 (AF/CF) |
| Tensile shear strength [MPa] | 0.46 ± 0.05 (CF) | 0.22 ± 0.05 (CF) |

Legend: AF: adhesion fracture; CF: cohesion fracture

The adhesive films K1 and R1 have an identical chemical composition. Only the production method is varied. R1 is thus coated by means of standard coating methods in the 2-roller application in a width of 450 mm and band polymerized. In contrast thereto, K1 is applied by means of a polyjet modeling method in the width to be tested and also band polymerized. The two adhesive films have different thicknesses due to the type of production, however.

The adhesive compounds K1 and R1 have equal adhesion both initially and also after 24 hours in the scope of the standard deviation.

With respect to the tensile shear strength, however, K1 has a higher tensile shear strength than R1, which is to be attributed according to experience to the lower adhesive layer thickness, however. The tensile shear strengths would thus also be equal in the scope of the standard deviation at identical adhesive layer thickness.

Overall, it can thus be stated that the geometrically defined pressure-sensitive adhesive layer which was produced by means of a polyjet modeling method has the same adhesive-technology properties as a conventional coated adhesive film.

If applicable, all individual features which are represented in the exemplary embodiments can be combined and/or exchange with one another without leaving the scope of the invention.

### LIST OF REFERENCE SIGNS

1 unroller
2 printing head having the nozzles
3 irradiation/drawing
4 roller
5 adhesive tape transport liner

1.-16. (canceled)

17. An adhesive tape having at least one pressure-sensitive adhesive film, which is capable of connecting two joining partners to one another only by applying pressure, wherein the adhesive tape is designed either as a transfer adhesive tape, wherein the adhesive tape is applied to a release liner or between two release liners and the release liners are provided to be pulled off upon an application of the transfer adhesive tape to expose adhesive surfaces of the adhesive film, or is designed as a rolled adhesive tape having a single double-sided repellent liner characterized in that the adhesive film is produced by means of a polyjet modeling method, wherein the adhesive is applied by means of piezoelectric actuators in the nozzles at frequencies between 10 kHz and 100 kHz to the release liner or the double-sided repellent liner and no subsequent shaping process takes place.

18. The adhesive tape as claimed in claim 1, characterized in that the adhesive film has geometrically defined forms in both a two-dimensional and three-dimensional aspect.

19. The adhesive tape as claimed in claim 1, characterized in that the adhesive film has UV acrylates, hot melts, and/or solvent-based and water-based acrylates and is printed in the viscosity range from 2 mPas to 100 mPas.

20. The adhesive tape as claimed in claim 1, characterized in that the applied drop volume varies between 2 and 200 pl.

21. The adhesive tape as claimed in claim 1, characterized in that the adhesive film consists of multiple different adhesive film layers, which are both variations of UV acrylates, hot melts, and solvent-based and water-based acrylates and also variations of the four different chemistries.

22. The adhesive tape as claimed in claim 1, characterized in that the adhesive film has a thickness of between 1 μm and 3000 μm.

23. The adhesive tape as claimed in claim 1, characterized by a functionalization to create a thermal or electrical conductivity.

24. The adhesive tape as claimed in claim 1, characterized by a functionalization to create active ingredient patches by means of drugs or medical active ingredients.

25. The adhesive tape as claimed in claim 1, characterized by a functionalization by means of herbicides and biocides.

26. The adhesive tape as claimed in claim 1, characterized by a coloration of the adhesive films and/or a display of color effects of the adhesive film.
